(19) United States
(12) Patent Application Publication
(10) Pub. No.: US 2003/0126776 A1
(43) Pub. Date: Jul. 10, 2003

(54) Quick response system and method for producing voluminous custom plush products

(75) Inventors: Michael Lewis, Westfield, NJ (US); Geoff Geruso, Weehawken, NJ (US); Virginia Patton, Lake Hiawatha, NJ (US)

Correspondence Address: FOLEY AND LARDNER, SUITE 500, 3000 K STREET NW, WASHINGTON, DC, 20007, US

(73) Assignee: Team Beans Authentic, L.L.C.

(21) Appl. No.: 10/300,925

(22) Filed: Nov. 21, 2002

Related U.S. Application Data
(60) Provisional application No. 60/331,720, filed on Nov. 21, 2001.

(51) Int. Cl. H01J 9/00

(52) U.S. Cl. 40/545; 445/24

(57) ABSTRACT

A system and method for manufacturing a product from a plurality of parts based on the result of an event includes designing each of a first group of the plurality of parts with a generic design and designing each of a second group of the plurality of parts with a customized design. Each of the second group of parts has at least two versions of the customized design. The first group of parts is manufactured into a partially completed product, and the second group of parts is manufactured separately. After receiving a result of the event, the manufacture of the product is completed with the partially completed product and the second group of parts designed with a version consistent with the result of the event.

### FIELD OF THE INVENTION

The present invention relates generally to quick response production systems, and more particularly to a system and method for generating large volume productions of custom plush products.

### BACKGROUND OF THE INVENTION

Novelty items for various sports teams and athletes, such as tee shirts, mugs, hats and other items, can be purchased at most athletic events or at sports-related retail outlets. For some events, such as professional championship games, collegiate tournaments and bowl games and high school competitions, the novelty items are typically modified to acknowledge the involvement of the team or athlete in the applicable event. Most of the novelty items, such as tee shirts and hats, can be quickly manufactured to show this involvement, such as a professional football team playing in or winning the Super Bowl. In particular, tee shirts and hats can be quickly printed or embroidered with the applicable logo or name.

For other novelty items, particularly three-dimensional items such as plush products like stuffed bears, the turnaround time is significantly longer to produce customized logos or names to show involvement in some event. For example, to show the winner of the Super Bowl on a plush product may take as long as two weeks, at which point the novelty of and demand for the product may have diminished. Unlike tee shirts and hats, the three-dimensional items cannot be embroidered after the item has already been manufactured, which results in the production time being longer for embroidered or customized designs ornamented directly on the three-dimensional items. Accordingly, it would be desirable to be able to produce three-dimensional items, such as plush products, more quickly.

### SUMMARY OF THE INVENTION

Briefly, in one aspect of the present invention, a method for manufacturing a product from a plurality of parts based on the result of an event includes designing each of a first group of the plurality of parts with a generic design and designing each of a second group of the plurality of parts with a customized design. Each of the second group of parts has at least two versions of the customized design. The first group of parts is manufactured into a partially completed product, and the second group of parts is manufactured separately. After receiving a result of the event, the manufacture of the product is completed with the partially completed product and the second group of parts designed with a version consistent with the result of the event.

In another aspect of the present invention, the partially completed product is manufactured prior to receiving the result of the event.

In yet another aspect of the present invention, possible results of the event are identified, and each of the versions of the second group of parts is designed in accordance with a respective one of the identified possible results of the event.

### BRIEF DESCRIPTION OF THE DRAWINGS

FIG. 1 shows an example of a plush product stuffed bear customized to identify the World Series most valuable players (MVPs) from the 2001 World Series.

FIG. 2 is a flow diagram for a production process consistent with the present invention.

FIG. 3 are examples of two different templates for use in the production process of FIG. 2.

### DETAILED DESCRIPTION OF THE PREFERRED EMBODIMENT

Plush products, such as stuffed bears, have a multitude of seams coupling together different parts of the product. With a stuffed bear, for example, each one may have separate parts for each foot, leg, arm, chest, back, head, ears, etc. Each of these separate parts may be further divided into additional parts. Each of the separate parts may include their own ornamental design.

To reflect the involvement of a team or player in an event on a customized plush product, much of the ornamental design may be generic to the event, regardless of whom is competing in the event. For example, a plush product for the World Series may have generic ornamental designs and colors for the World Series that cover most of the parts of the plush product. The remaining one or more parts of the plush product can be customized to identify the teams or players in the World Series.

In addition to athletic events, plush products can be customized to reflect more personalized events. For example, the conditional event upon which the plush product is customized may be the birth of a child, a birthday, a graduation, a wedding, an anniversary, or a holiday celebration, such as Father's and Mother's day. In addition, the event may refer to membership in a group, such as a person's Zodiac sign or membership in a club. In general, the event refers to an episode upon which a customized design of a plush product depends. For the purposes of this description, the following explanation will refer to athletic events, but those skilled in the art will understand the applicability to other types of events, such as those described above.

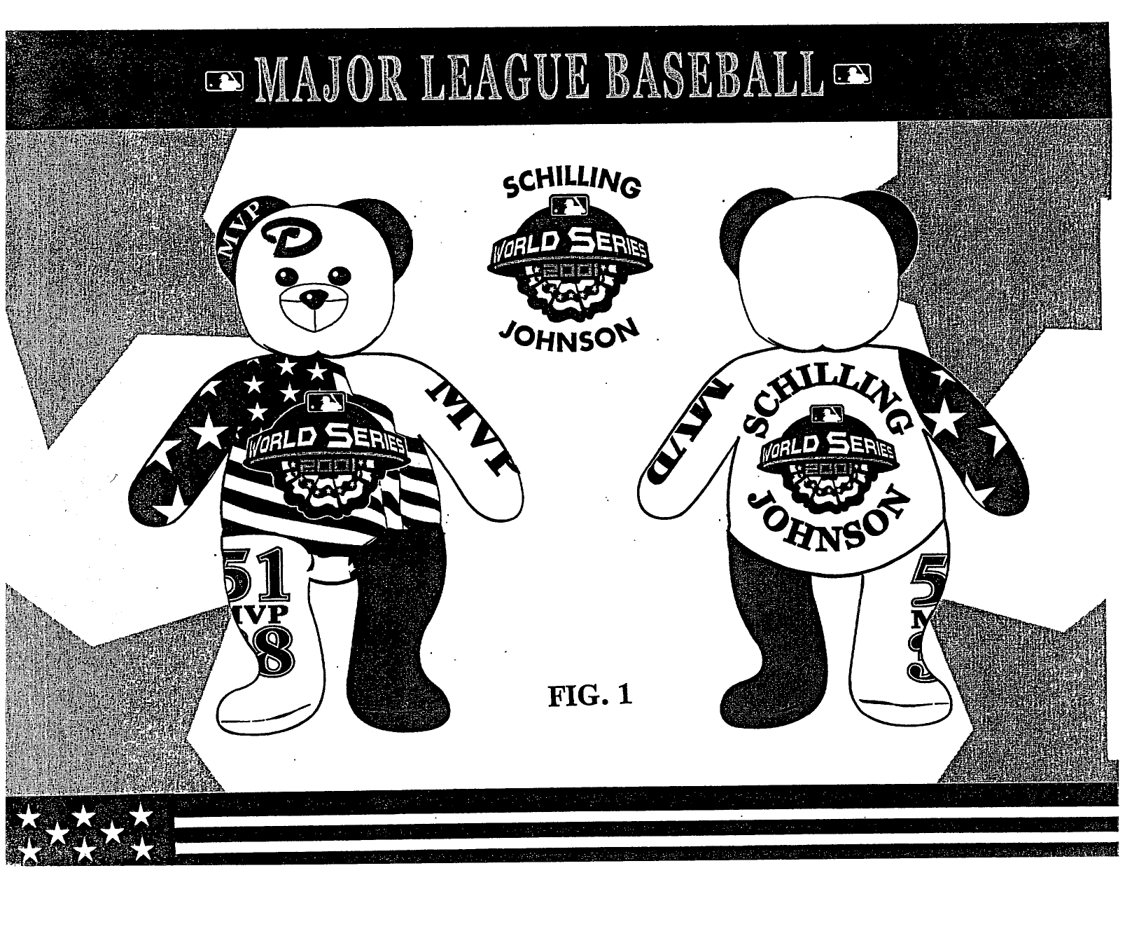

FIG. 1 shows an example of a plush product stuffed bear customized to identify the World Series most valuable players (MVPs) from the 2001 World Series, Curt Schilling and Randy Johnson. As shown in FIG. 1, most of the parts of the bear are generic to identifying the World Series MVP, including the logo for the 2001 World Series on the chest, colors and designs representing the U.S. flag on one arm and the chest, and the acronym MVP on one ear and the other arm. The leg is customized to identify the numbers of the 2001 co-MVPs, the head includes a logo for the Arizona Diamondbacks, the team for which Schilling and Johnson play, and the back includes the names of the co-MVPs.

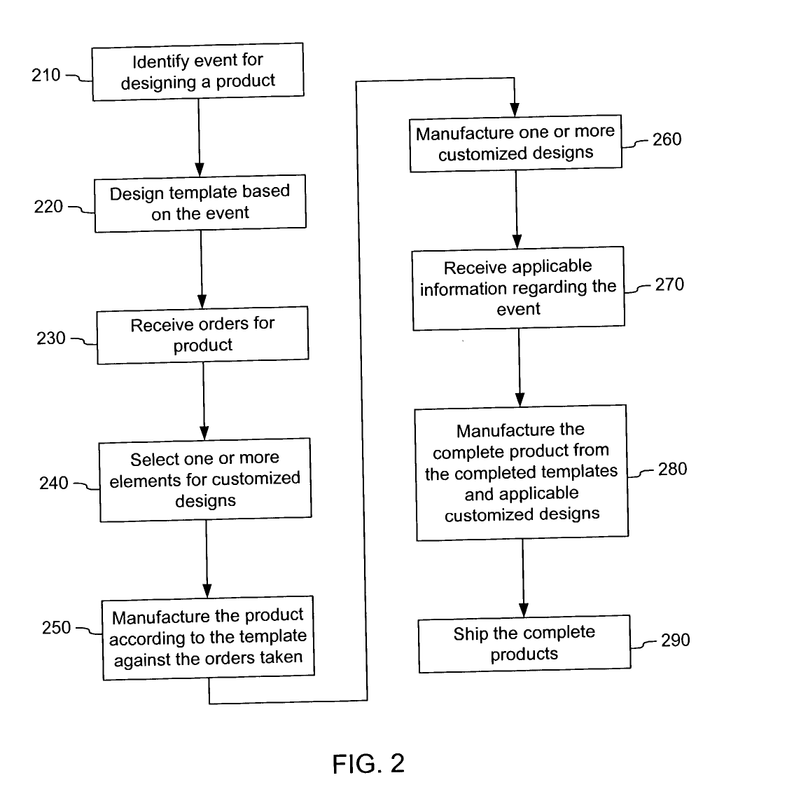

In one aspect of the present invention, the production time for producing a customized plush product, such as the bear shown in FIG. 1, can be significantly reduced. FIG. 2 is a flow diagram for a production process consistent with the present invention. First, the manufacturer identifies an event for designing a product (step 210). The event relates to the purpose the product is being manufactured. In addition, the completion or other applicable information of the event affects the design of the product. The event may be, for example, an athletic event at the professional, collegiate or high school level in any sport. Typical events include the Super Bowl, the World Series, collegiate bowl games, the NCAA Tournament (college basketball), high school playoffs, etc.

For each of these types of events, the participants are not known until a short time before the event takes place. Of course, the result of the event, and awards, e.g., the most valuable player (MVP), for the event are not known until the event is complete. For the time that this type of information is not known, it is not possible to manufacture the product that reflects the participants in the event. For example, until the American and National League Championship Series (ALCS and NLCS) are complete, the participants in the World Series are not known. Similarly, until the World Series is complete, the MVP is not known.

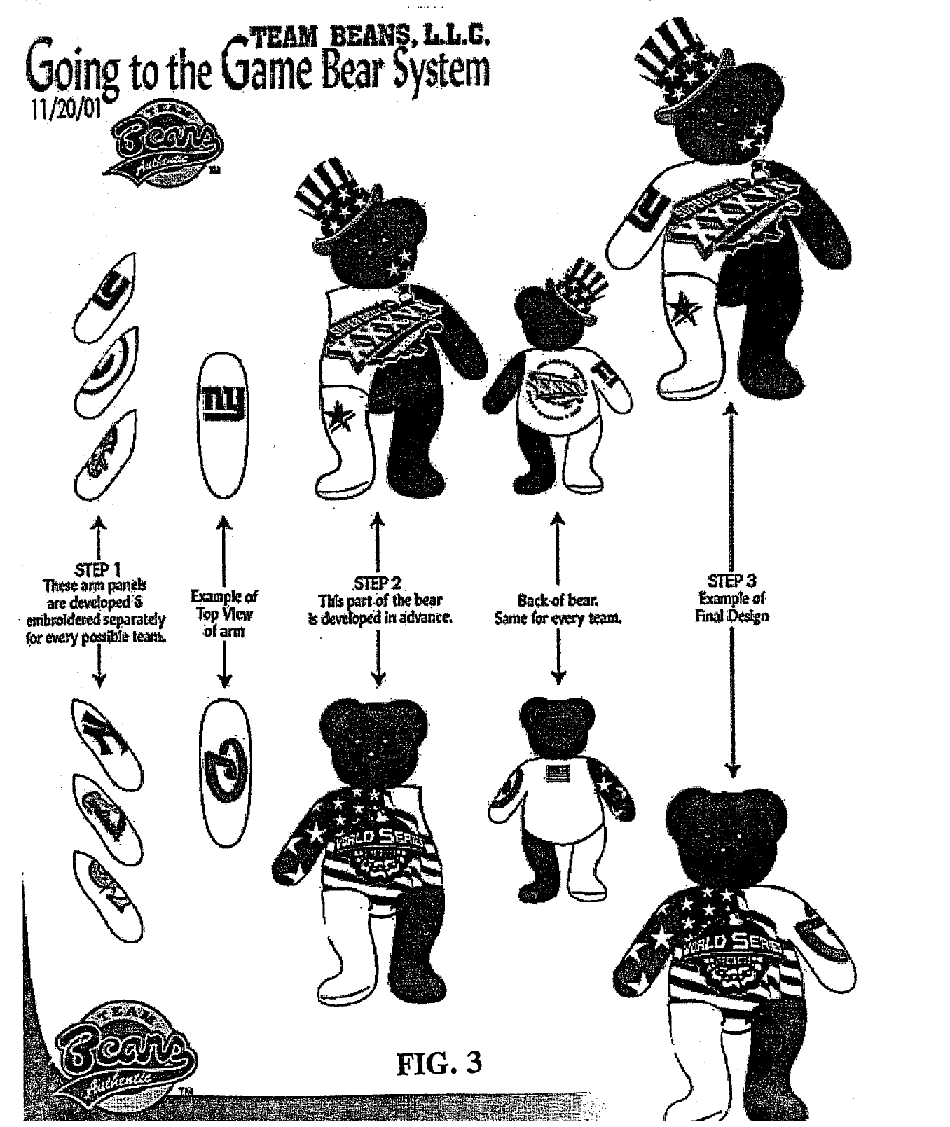

Based on the identified event, a template is designed for the product (step 220). The template shows how each part of the product is to be designed for the product. For example, if the product is a plush product, such as a stuffed bear, the product has a plurality of parts corresponding to the different body areas of the bear or however many pieces are sewn together to form the bear. Each part may have its own design or several parts may merge together to form a single design. FIG. 3 are examples of two different templates showing the design for each part of a bear where the events are the Super Bowl and the World Series. The template may be designed using standard graphic design software or other software capable of creating design templates.

Depending on the template, much of the design for the product may be independent of the undetermined information for the event to make the design. For example, if the stuffed bear is designed for a team that is going to compete in the World Series, most of the parts of the bear would be designed to show representation in the World Series. The remaining one or more parts would be designed to show one or both of the participants in the World Series.

Based on the template for the event, one or more orders are received for the manufacture of the product (step 230). The template for the event can be sent to one or more vendors, who then send orders to the manufacturer based on the template for the event. The product order may specify the type of product, any requirements or design requests for the product beyond what is shown in the template, the event for which the product is being ordered, the number of products to be ordered, information identifying the source of the order, payment information, and any other information that may be useful to processing the order.

The type of product may be, for example, a plush product, such as a stuffed bear. The event may be a professional, collegiate, high school or other sporting event, such as the World Series, Super Bowl, the Rose Bowl or the Final Four. For any of these events, the participants are unknown until a short time before the event, and of course, the winners and award winners are unknown until after the event is complete.

The order may be supplied to the manufacturer of the product in a variety of ways. For example, the order may be taken by telephone at a call order processing center. Alternatively, the party making the order may log on to a web site, fill out an order form with the applicable information, and submit the order electronically to the manufacturer. To implement such a processing system, the manufacturer may set up the web site and have onsite computing capabilities to receive the order and process it accordingly.

In the template, one or more parts or elements of the product are selected for customized designs (step 240). As described above, the design of most, or at least some, of the parts or elements of the product are not dependent on the undetermined information of the event. The designer of the template may select one or more of the parts of the product to show designs based on the undetermined information. For example, if the product is the bear, and the event is the World Series, one or more parts of the bear, such as the arm and back, could include logos or designs for one or both of the participants in the World Series.

For the elements of the product selected for customized designs, the content of the customized designs is undetermined until some time before the event or until after the completion of the event. However, it is possible to identify the possible participants in the event, the possible winners in the event, or the possible award winners of the event some time before the participants and winners are known. For example, during the ALCS and NLCS, the pool of possible participants in the World Series is only four. Similarly, once the participants in the World Series are known, the pool of possible winners of the World Series is only two. Accordingly, it is possible to create a limited number of customized designs for the selected one or more elements.

As shown in FIG. 3, in the 2001 World Series, some of the potential participants were the Yankees, the Cardinals, the Mariners and the Diamondbacks, which were all teams that made the playoffs. For the proposed bear, the generic part of the template includes all of the bear design except for the left arm. The left arm includes the logo of the potential participant embroidered on it. Accordingly, the left arm of the bear corresponds to the part of the product for customized design. The different logos for the potential participants correspond to the different versions of the customized design.

Having created the template for the product and the selected customized designs, the product is manufactured according to the template in accordance with the order taken (step 250). The type of product determines the type of manufacturing equipment to make the product. In manufacturing the product according to the template, a complete product is not built. In particular, the part of the product corresponding to the customized design elements are not immediately incorporated in the product.

The one or more customized design elements are manufactured separately from the rest of the product (step 260). Multiple versions of the customized design elements are manufactured in accordance with the identified event. For example, if the customized design elements correspond to the participants in the World Series, four versions of the customized design elements may be manufactured during the ALCS and the NLCS, two versions for the two teams in the ALCS and two versions for the two teams in the NLCS.

After manufacturing the product according to the template the multiple versions of the customized design elements, the applicable event information is received (step 270). The applicable event information depends upon the requested content for the customized design elements. For example, if the event is the World Series, the requested content for the product may be to show the participants in the World Series, the winner of the World Series, or the World Series MVP. If the requested content is to show the winner of the World Series, then the applicable event information would be received once the winner of the World Series is known.

Once the applicable event information is received, the complete product can be manufactured from the previously manufactured templates and the applicable customized design elements (step 280). Having received the applicable event information, the applicable version of the customized design elements can be determined and incorporated into the previously manufactured templates to create the complete product. For example, if the applicable event information is the winner of the World Series, the version of the customized design elements corresponding to the winner of the World Series would be incorporated into the previously manufactured templates.

The complete products are shipped to the party that made the order (step 290). The original order preferably includes the address of the party to which to ship the product, as well as the type of shipping.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for manufacturing a product from a plurality of parts based on the result of an event, comprising:
designing each of a first group of the plurality of parts with a generic design;
designing each of a second group of the plurality of parts with a customized design, each of the second group of parts having at least two versions of the customized design;
manufacturing the first group of parts into a partially completed product;
manufacturing separately the second group of parts;
receiving a result of the event; and
completing the manufacture of the product with the partially completed product and the second group of parts designed with a version consistent with the result of the event.

2. A method according to claim 1, wherein the partially completed product is manufactured prior to receiving the result of the event.

3. A method according to claim 1, wherein the product is a plush product.

4. A method according to claim 1, wherein the event is an athletic event.

5. A method according to claim 1, wherein each of the versions of the second group of parts is dependent upon the result of the event.

6. A method according to claim 1, further comprising:
identifying possible results of the event;
designing each of the versions of the second group of parts in accordance with a respective one of the identified possible results of the event.

7. A method according to claim 1, further comprising:
identifying the event for which the product is being manufactured; and
designing each of the plurality of parts of the template in accordance with the identified event.

8. A system for manufacturing a product from a plurality of parts based on the result of an event, comprising:
a product design component which designs each of a first group of the plurality of parts with a generic design and each of a second group of the plurality of parts with a customized design, each of the second group of parts having at least two versions of the customized design; and
a product manufacturing component which manufactures the first group of parts into a partially completed product and separately manufactures the second group of parts,
wherein the product manufacturing component completes the manufacture of the product with the partially completed product and the second group of parts designed with a version consistent with a result of the event.

9. A system according to claim 8, wherein the partially completed product is manufactured by the product manufacturing component prior to completion of the event.

10. A system according to claim 8, wherein the product is a plush product.

11. A system according to claim 8, wherein the event is an athletic event.

12. A system according to claim 8, wherein each of the versions of the second group of parts is dependent upon the result of the event.

13. A system according to claim 8, wherein the event has at least two possible results, and the product design component designs each of the versions of the second group of parts in accordance with a respective one of the at least two possible results of the event.

14. A system according to claim 8, wherein the product design component designs each of the plurality of parts of the template in accordance with the event.
